(19) United States
(12) Patent Application Publication
(10) Pub. No.: US 2017/0232626 A1
(43) Pub. Date: Aug. 17, 2017

(54) Pizza Cutter

(71) Applicant: James Siegrist, Cathedral City, CA (US)

(72) Inventor: James Siegrist, Cathedral City, CA (US)

(21) Appl. No.: 15/430,985

(22) Filed: Feb. 13, 2017

Related U.S. Application Data
(60) Provisional application No. 62/388,988, filed on Feb. 16, 2016.

(51) Int. Cl. B26B 25/00; B26B 29/00

(52) U.S. Cl. CPC B26B 25/005; B26B 29/00

(57) ABSTRACT

A pizza cutter in the form of a disc having three or more edges, a series of rounded corners, equal in number to the three or more edges, which form the interfaces between adjacent edges, a handle having a proximal end and a distal end, an arm located at the proximal end of the handle, the proximal end and the distal end separated by a guard, and the disc connected to the arm.

### CROSS REFERENCES TO RELATED APPLICATIONS

This original non-provisional application claims priority to, and the benefit of, U.S. provisional application 62/388,988, filed Feb. 16, 2016, which is incorporated by reference.

### FEDERALLY SPONSORED RESEARCH

Not applicable.

### BACKGROUND OF THE INVENTION

1. Field of the Invention

The present invention relates generally to cutlery. More specifically, the present invention relates to a pizza knife that improves the pizza slicing process.

2. Description of the Related Art

Pizza knives, also referred to as pizza wheels, require a blade, and in most instances a handle attached to the blade. Over time, pizza wheels have taken on a familiar arrangement of a round blade—shaped like a wheel—wherein most of, if not the entire, perimeter of the wheel is a blade. To accommodate 360° of blade, the handle is typically arranged such that an end of the handle connects proximal to the center of the wheel's two faces. The handle extends away from the blade and terminates at an end distal therefrom.

The familiar arrangement described above provides several benefits relative to using a knife. First, pizzas are relatively large compared to other food items (e.g., an apple) and requires several lengthy cuts. By using a rotatable wheel-like blade, the user can use a relatively small knife to cut large lengths of pizza. Second, using a wheel-like blade allows the user to slice diameter lengths of a pizza with a single pull, rather than repeated back and forth cutting motions. Both benefits are improvements over traditional bread knives.

There are, however, downsides to existing pizza wheels. For one, pizza wheels often get “stuck” in the cheese and bread of a pizza. The thin, rotatable attributes familiar to pizza wheels creates a shortcoming in terms of cutting through the intended media—pizza.

### BRIEF SUMMARY

The present invention comprises an apparatus in the form of a disc having three or more edges, a series of rounded corners, equal in number to the three or more edges, which form the interfaces between adjacent edges, a handle having a proximal end and a distal end, an arm located at the proximal end of the handle, the proximal end and the distal end separated by a guard, and the disc connected to the arm.

### BRIEF DESCRIPTION OF THE DRAWINGS

FIG. 1 is a front view of an embodiment of the present invention.

FIG. 2 shows a left planar view of the embodiment shown in FIG. 1.

FIG. 3 shows the invention in operation cutting a pizza.

### DETAILED DESCRIPTION OF CERTAIN EMBODIMENTS

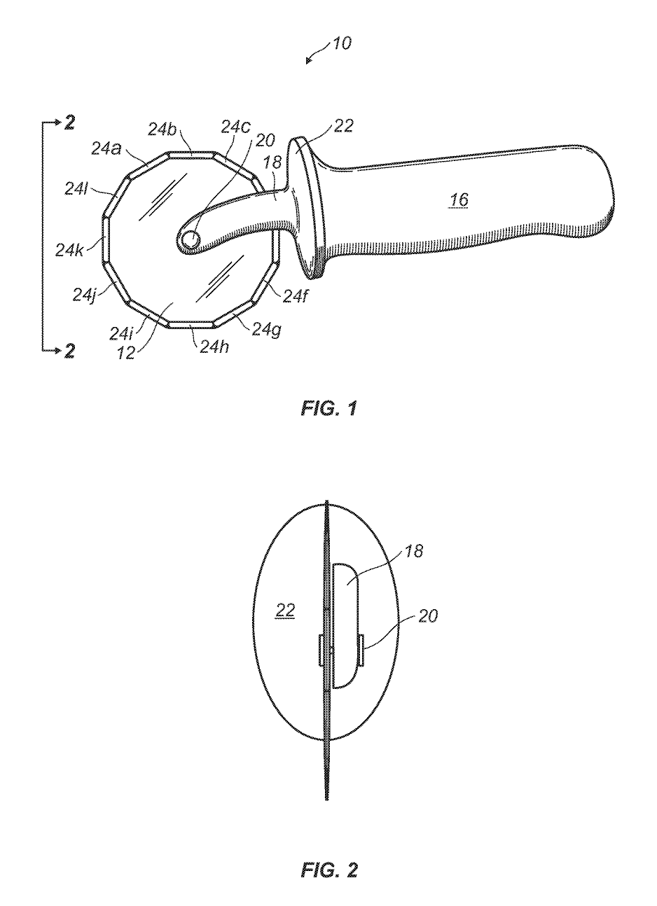

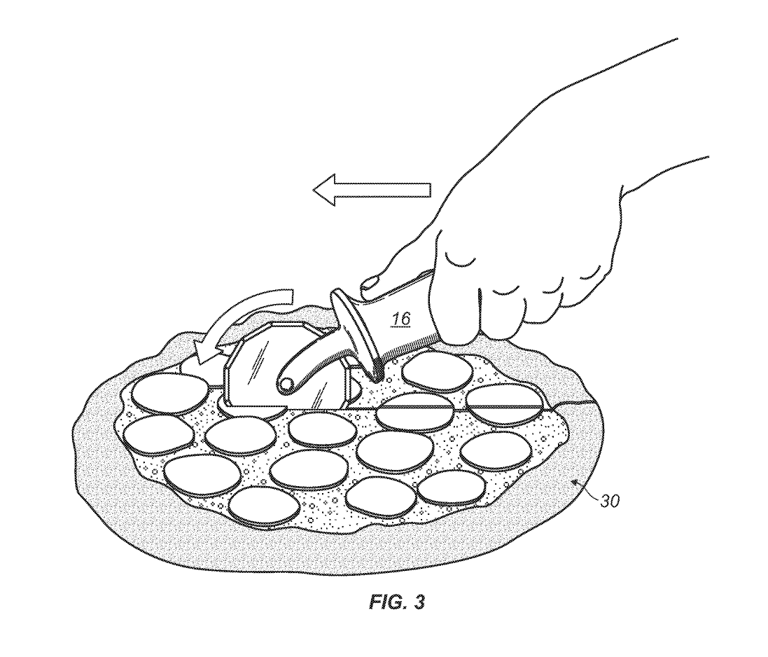

Referring to FIGS. 1-3, this embodiment of the cutting wheel 10 comprises a metal disc blade 12 and a handle 16. The handle 16 has a rigid arm 18 on one end. The metal disc blade 12 has a circular opening (not shown) allowing for an axle 20 to pass through. The axle 20 connects the metal disc blade 12 and the rigid arm 18. The axle 20 allows for rotation of the metal disc blade 12. The axle 20 also prevents the rigid arm 18 (and effectively the handle 16) and the metal disc blade from shifting translationally apart from one another.

In this embodiment, the cutting wheel 10 comprises a safety guard 22 positioned between the handle 16 and the rigid arm 18. The safety guard 22 serves several functions. First, the safety guard 22 increases safety by reducing, if not eliminating, the possibility a user might lose his grip and cut himself. This is a problem with traditional pizza wheels not comprising a guard. Second, the safety guard reduces the user's exposure to pizza ingredients (e.g., cheese, pizza sauce).

In this embodiment the guard is generally characterized as a cylindrical plate of uniform thickness, and approximately the size of a human hand. In other embodiments, the guard may be convex, concave, or both. The guard might not be an oval, but instead a different shape. The guard might be larger or smaller than illustrated in FIGS. 1-3.

Certain embodiments of this device may be characterized having a rotatable blade with three or more edges. The embodiment illustrated and described herein comprises a metal disc wheel blade 12 with twelve edges 24a, 24b, 24c, 24d, 24e, 24f, 24g, 24h, 24i, 24j, 24k, 241 (not enumerating edges 24d, 24e). Some embodiments have rounded corners joining each of the edges. The embodiment illustrated and described herein comprises a metal disc wheel blade 12 with rounded corners 26ab, 26bc, 26cd, 26de, 26ef, 26fg,26gh, 26hi, 26ij, 26jk, 26k1, 261a, joining the edges 26ab, 26bc, 26cd, 26de, 26ef, 26fg,26gh, 26hi, 26ij, 26jk, 26k1, 261a, respectively.

In alternative embodiments the rigid arm 18 may fork such that the axle 20 passes through a first sub-arm on one side of the metal disc blade 12 and through a second sub-arm on the other side of the metal disc blade 12.

Edges and rounded corners such as those described above improves the usability of a pizza wheel. Edges, in particular, slices through the combination of cheese, sauce, pizza crust and other ingredients more effortlessly and effectively than traditional rounded circular pizza wheels. This occurs because the user applies the same amount of force on the cutting wheel 10 as he would on a traditional pizza wheel, yet higher percentage of that force is applied from the rumble wheel onto the pizza. More specifically, cutting the pizza with a rumble wheel is cutting with micro-chops, rather than slices. Moreover, the rounded corners improve transition from one micro-chop to the next. The user may then pull a rumble wheel across the pizza from one chop to the next.

Persons skilled in the art will recognize that using twelve generally planar faces and twelve rounded corners is not limiting. Alternative embodiments may comprise more or less generally planar faces and rounded corners. Similarly, persons of skill in the art will recognize that such generally planar faces and rounded corners need not be equal-length or equal-angular, respectively. And the rounded corners need not exhibit the same level or roundedness (i.e., curvature) as illustrated in the attached figures. In some embodiments, the corners might not necessarily be rounded.

Additionally, and in some embodiments, the metal disc blade may be wider or might not taper as much as the embodiment described herein. In such embodiments it is envisioned that a disc blade might have three or more generally planar faces. It is further envisioned that in a sub-set of such embodiments, the generally planar faces made be joined by rounded edges.

In some embodiments a handle might further comprise a hand grip or other features associated with handles used in cutlery and cooking utensils.

In alternative embodiments, the handle may not connect to the disc at an end, but instead may connect somewhere in between. And the handle might not connect at the center of the disc, but instead somewhere else along one or both faces of the disc.

FIG. 3 shows the embodiment of the cutting wheel 10 described above as it might be used when cutting a pizza 30.

Although the present invention has been described with reference to specific embodiments, this description is not meant to be construed in a limiting sense. Various modifications of the disclosed embodiments, as well as alternative embodiments of the invention will become apparent to persons skilled in the art upon the reference to the above description of the invention. It is, therefore, contemplated that the appended claims will cover such modifications that fall within the scope of the invention.

I claim:

1. A pizza cutter comprising:
a disc having three or more edges;
a series of rounded corners, equal in number to the three or more edges, each corner being adjacent to two of the edges;
an arm connected to the disc;
the arm connected to a handle;
the handle having a first end proximal to the arm and a second end distal from the arm; and
a guard positioned along the handle in between the first end and the second end.

2. The pizza cutter of claim 1 wherein the handle extends generally parallel and radially away from disc.

3. The pizza cutter of claim 1 wherein the handle connects to the disc on or through the disc's central axis.

4. The pizza cutter of claim 3 wherein the handle connects to the disc on or through the disc's central axis; and the disc is freely rotatable about its central axis.

5. The pizza cutter of claim 1 wherein the arm is rotationally connected to the disc.

6. The pizza cutter of claim 1 wherein the guard is generally ovular in shape.

7. A pizza cutter comprising:
a disc having twelve edges of equal length, a center, a first opening located at the center of the disc;
a series of twelve rounded corners, each corner being adjacent to two of the edges;
a handle having a proximal end and a distal end;
a rigid arm positioned along the proximal end of the handle and having a second opening,
which is the same size as the first opening;
a hand grip positioned along the distal end;
the hand grip and rigid arm separated by an ovular guard;
an axle that passes through the first opening and the second opening;
a first cap and a second cap;
the first cap positioned on a first end of the axle; and
the second cap positioned on a second end of the axle.
